(19) United States
(12) Patent Application Publication
(10) Pub. No.: US 2020/0386194 A1
(43) Pub. Date: Dec. 10, 2020

(54) LEAKAGE DIAGNOSIS DEVICE

(71) Applicant: DENSO CORPORATION, Kariya-city (JP)

(72) Inventors: Taiki YASUZAKA, Kariya-city (JP); Yasuo KATOH, Kariya-city (JP)

(21) Appl. No.: 16/893,915

(22) Filed: Jun. 5, 2020

(30) Foreign Application Priority Data
Jun. 10, 2019 (JP) 2019-108187

(51) Int. Cl. F02M 25/08

(52) U.S. Cl. CPC F02M 25/0818; F02M 2025/0845; F02M 25/089; F02M 25/0854

(57) ABSTRACT

An evaporative fuel treatment device includes a canister configured to adsorb fuel vapor arising in a fuel tank of an internal combustion engine. A vent passage is connected to a system to be diagnosed, which includes the canister, and opens to atmosphere. A pump is connected to the vent passage and decreases and increases pressure in the system. A switching valve is provided to the vent passage and switches a communication state between the vent passage and the system. At least a part of a rotational portion of the pump, a contact portion of the pump, and the vent passage is formed of a carbon-containing material. The contact portion is in contact with the rotational portion. The carbon-containing material is mainly composed of carbon.

### CROSS REFERENCE TO RELATED APPLICATION

The present application claims the benefit of priority from Japanese Patent Application No. 2019-108187 filed on Jun. 10, 2019. The entire disclosures of all of the above applications are incorporated herein by reference.

### TECHNICAL FIELD

The present disclosure relates to a leakage diagnosis device.

### BACKGROUND

Conventionally, an evaporative fuel treatment device includes a canister to adsorb evaporative fuel that arises in a fuel tank of an internal combustion engine. A leakage diagnosis device is used for the evaporative fuel treatment device to perform a leakage diagnosis of the evaporative fuel.

### SUMMARY

According to an aspect of the present disclosure, a leakage diagnosis device is configured to diagnose leakage of vapor in an evaporative fuel treatment device. The evaporative fuel treatment device includes a canister that is configured to adsorb fuel vapor arising in a fuel tank of an internal combustion engine. The leakage diagnosis device comprises a vent passage that is connected to a system to be diagnosed and that opens to atmosphere. The system to be diagnosed includes the canister.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a configuration of a leakage diagnosis device according to a first embodiment;

FIG. 2 is a schematic sectional view of a pump according to the first embodiment;

FIG. 3 is a sectional view taken along the line III-III in FIG. 2;

FIG. 4 includes diagrams in which (a) shows a relationship between a carbon content rate and a dimensional accuracy and in which (b) shows a relationship between the carbon content rate and a strength according to the first embodiment;

FIG. 5 is a timing chart showing a leakage diagnosis procedure according to the first embodiment;

FIG. 6 is a schematic diagram showing a configuration of a leakage diagnosis device according to a first modification; and

FIG. 7 is a schematic view showing a section of a pump according to a second modification.

### DETAILED DESCRIPTION

Hereinafter, examples of the present disclosure will be described.

According to an example, an evaporative fuel treatment device includes a canister configured to adsorb evaporative fuel that arises in a fuel tank of an internal combustion engine. A leakage diagnosis device is used for the evaporative fuel treatment device to perform a leakage diagnosis of the evaporative fuel.

In an example of the present disclosure, a leakage diagnosis device performs a leakage diagnosis of a system to be diagnosed based on a pressure change when the inside of the system to be diagnosed including the canister of the evaporative fuel treatment device is depressurized by using a pump. The pump is connected to a ventilation pipe of the canister.

The pump includes pump components. The pump components, for example, include a rotational portion such as a rotor and a contact portion including multiple vanes that come into contact with the rotor. According to an assumable example, these pump components may be made of a phenol resin material. It is noted that, the phenolic resin material is low in dimensional accuracy when being molded. Therefore, these pump components may generally require a polishing process after being molded in order to enhance its dimensional accuracy. In addition, the polishing process to enhance the dimensional accuracy may be technically difficult. Therefore, the manufacturing yield of these pump components may be insufficient.

According to an example of the present disclosure, a leakage diagnosis device is configured to diagnose leakage of vapor in an evaporative fuel treatment device. The evaporative fuel treatment device includes a canister that is configured to adsorb fuel vapor arising in a fuel tank of an internal combustion engine. The leakage diagnosis device comprises a vent passage that is connected to a system to be diagnosed and that opens to atmosphere. The system to be diagnosed includes the canister. The leakage diagnosis device further comprises a pump that is connected to the vent passage and is configured to decrease and increase pressure in the system to be diagnosed in the evaporative fuel treatment device. The leakage diagnosis device further comprises a switching valve that is provided to the vent passage and is configured to switch a communication state between the vent passage and the system to be diagnosed. The leakage diagnosis device further comprises a sensor configured to detect a physical quantity in the system to be diagnosed. The leakage diagnosis device further comprises a leakage diagnosis unit that is configured to perform leakage diagnosis based on a detection result of the sensor. At least a part of a rotational portion of the pump, a contact portion of the pump, and the vent passage is formed of a carbon-containing material. The contact portion is in contact with the rotational portion. The carbon-containing material is mainly composed of carbon.

The pump is configured to decrease or to increase pressure in the system to be diagnosed in the evaporative fuel treatment device. According to this example, in the leakage diagnosis device, at least a part of the rotational portion, the contact portion that is in contact with the rotational portion, and the vent passage of the pump is formed of a carbon-containing material that contains carbon as a main component. These components are formed of the carbon-containing material that is generally high in molding dimensional accuracy, and thus may exhibit sufficiently high molding accuracy after being molded in a molding die. As a result, these components may not require a polishing process after being molded in the molding die, and therefore may enable to omit a step of the polishing process and thereby to enable to enhance the manufacturing yield.

As described above, the present disclosure may enable to provide a leakage diagnosis device that enables to enhance the manufacturing yield.

### First Embodiment

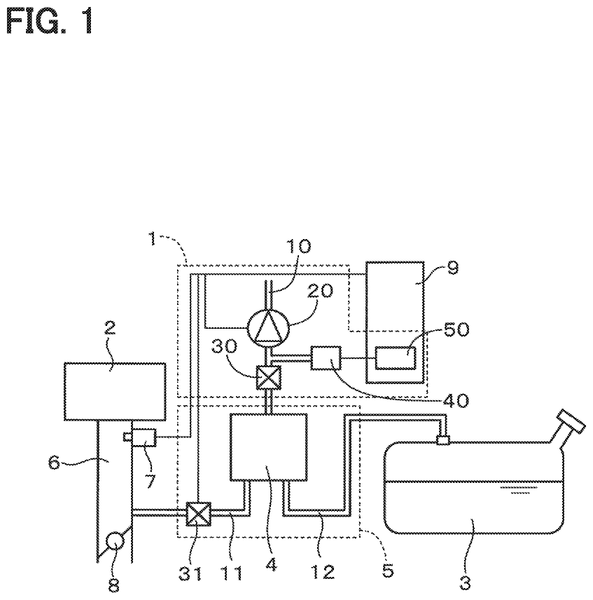

The present embodiment of a leakage diagnosis device will be described with reference to FIGS. 1 to 5.

A leakage diagnosis device 1 of the present embodiment is configured to perform a leakage diagnosis of vapor in an evaporative fuel treatment device 5. The evaporative fuel treatment device 5 includes a canister 4 that adsorbs evaporative fuel arising in a fuel tank 3 of an internal combustion engine 2. The leakage diagnosis device 1 includes a vent passage 10, a pump 20, a switching valve 30, a sensor 40, and a leakage diagnosis unit 50. The vent passage 10 is connected at one end to a system, which is to be diagnosed, including the canister 4. The vent passage 10 opens at the other end to the atmosphere. The pump 20 is connected to the vent passage 10 to decrease and increase pressure in the system, which is to be diagnosed, in the evaporative fuel treatment device 5. The switching valve 30 is placed in the vent passage 10 and is configured to switch a communication state between the vent passage 10 and the system to be diagnosed. The sensor 40 detects a physical quantity in the system to be diagnosed. The leakage diagnosis unit 50 performs leakage diagnosis based on the detection result of the sensor 40. At least a part of the rotational portion 21, the contact portions 22, 23, 24, which is in contact with the rotational portion 21, and the vent passage 10 of the pump 20 is formed of a carbon-containing material. More specifically, one or more, or all of the rotational portion 21, the contact portions 22, 23, 24, and the vent passage 10 may be formed of the carbon-containing material. The rotational portion 21, the contact portions 22, 23, 24, and/or the vent passage 10, which is formed of the carbon-containing material, may be entirely formed of the carbon-containing material or may be partially formed of the carbon-containing material.

The carbon-containing material contains carbon as a main component.

Hereinafter, the leakage diagnosis device 1 of the present embodiment will be described in detail.

As shown in FIG. 1, the evaporative fuel treatment device 5 having the system to be diagnosed for the leakage diagnosis device 1, which is to be diagnosed, is connected to the internal combustion engine 2. The evaporative fuel treatment device 5 includes the fuel tank 3, the canister 4 and a purge passage 11.

The fuel tank 3 stores fuel for the internal combustion engine 2. The canister 4 adsorbs evaporative fuel arising in the fuel tank 3. The purge passage 11 is a passage for drawing the evaporative fuel, which is adsorbed with the canister 4, into an intake system 6.

As shown in FIG. 1, a purge valve 31 is provided to the purge passage 11. The purge valve 31 opens and closes thereby to control supply of the evaporative fuel from the canister 4 to the intake system 6. An injector 7 is provided in an intake system 6 at a position in the vicinity of an intake port of the internal combustion engine 2. Further, the purge passage 11 is connected to the downstream of a throttle valve 8 in the intake system 6.

As shown in FIG. 1, the fuel tank 3 and the canister 4 are connected to each other through an evaporative fuel passage 12. In more detail, the evaporative fuel evaporating in the fuel tank 3 flows to the canister 4 through the evaporative fuel passage 12 connected to the top of the fuel tank 3.

As shown in FIG. 1, the vent passage 10 is connected to the canister 4 to draw air therethrough. The pump 20, the switching valve 30, and the sensor 40 are provided to the vent passage 10. The switching valve 30 opens to communicate the canister 4 to the atmosphere side to which the pump 20 and the sensor 40 are provided. The switching valve 30 closes to block the canister 4 from the atmosphere side. Note that the vent passage 10 may be formed of a carbon-containing material at least partially or entirely as to be described later.

In the present embodiment, the pump 20 is a decompression pump that discharges vapor from the system to be diagnosed to the atmosphere. As shown in FIG. 1, the purge valve 31 and the switching valve 30 are closed, thereby to enable to cause the system including both the canister 4 and the fuel tank 3 to be a closed system. In the present embodiment, this closed system is in the system (diagnosis object system) to be diagnosed. Subsequently, the purge valve 31 is maintained closed, the switching valve 30 is opened, and the pump 20 is activated. In this way, the pressure in the system to be diagnosed is decreased. Thereafter, the switching valve 30 is closed, thereby to blockade the inside of the system to be diagnosed under a negative pressure. In the present embodiment, each of the purge valve 31 and the switching valve 30 includes an electromagnetic valve. It is noted that, the pump 20 may be a pressurizing pump that sends air from the atmosphere side to the system to be diagnosed.

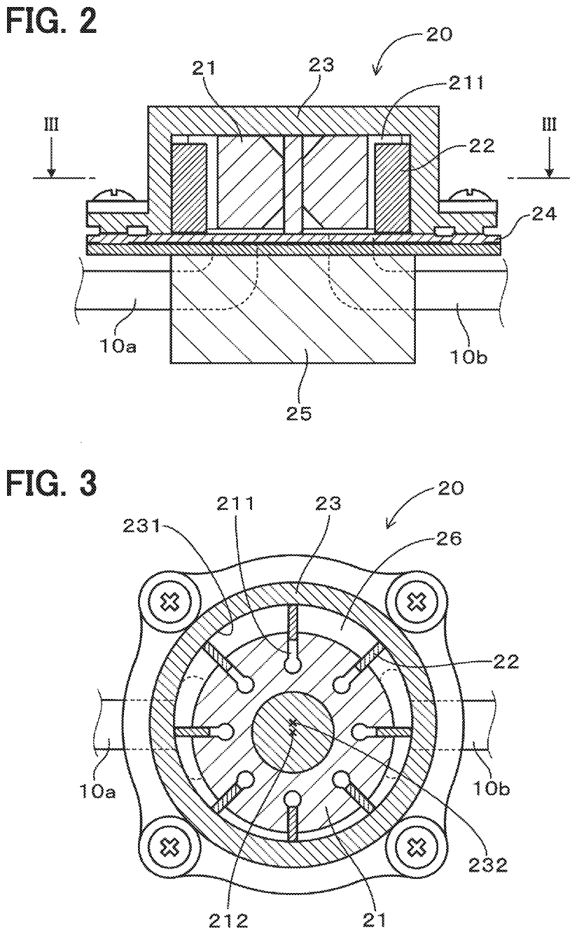

The pump 20 includes a rotational portion and a contact portion. The contact portion makes contact with the rotational portion. In this example, as shown in FIGS. 2 and 3, the pump 20 is a vane pump. The pump 20 includes a rotor 21 that is the rotational portion and includes vanes 22, a casing 23, and a plate 24 each of which is the contact portion. The rotor 21 is connected to a motor 25 and is configured to be rotational. As shown in FIG. 3, the inner peripheral surface of the casing 23 forms a cam ring, and the rotor 21 is provide inside the casing 23. Multiple grooves 211 are formed in the outer peripheral portion of the rotor 21. Each of the vanes 22 is in a flat plate shape. The vanes 22 are inserted into the grooves 211, respectively. The vanes 22 are urged onto an inner peripheral surface 231 of the casing 23 that forms the cam ring. The tip ends of the vanes 22 slide on the inner peripheral surface 231 of the casing 23, as the rotor 21 rotates. As shown in FIG. 3, a rotational center 212 of the rotor 21 and a center 232 of the inner peripheral surface 231 of the casing 23 are at positions shifted from each other. As the rotor 21 rotates, each of spaces 26, which is defined among the rotor 21, the vanes 22 and the inner peripheral surface 231 of the casing 23, rotates while changing in volume. In this way, the pump 20 is configured to transport vapor from a pipe 10a on the suction side to a pipe 10b on the discharge side.

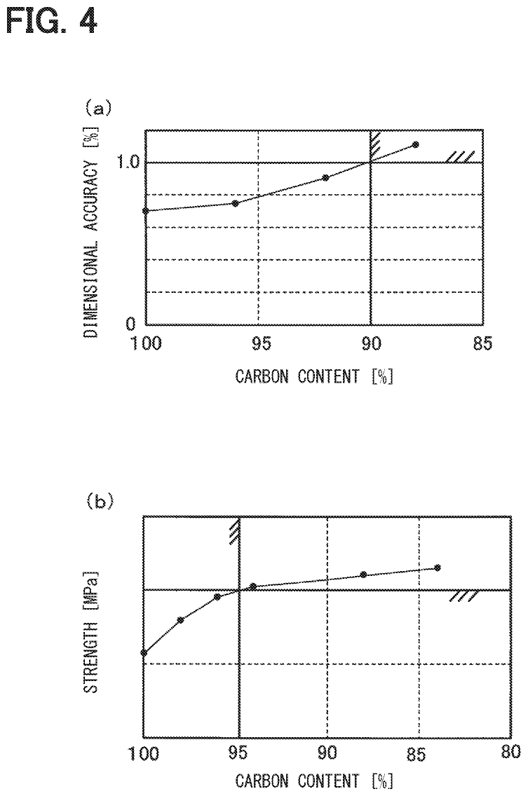

In the pump 20, at least a part of the rotor 21 which is the rotational portion, the vanes 22 each being the contact portion which makes contact with the rotational portion, the casing 23, the plate 24, and the vent passage 10 is formed of a carbon-containing material that contains carbon. In this example, the rotor 21, the vanes 22, and the casing 23 are formed of the carbon-containing material. These components are formed of the material containing carbon, thereby to enable to reduce a dimensional error of these molded product and to enhance these dimensional accuracy. As shown in (a) in FIG. 4, the higher the carbon content rate of the carbon-containing material, the better the dimensional accuracy. The dimensional accuracy is represented as a percentage of a difference, between the dimension of the molded product and the design dimension, with respect to the design dimension. In a case where the dimensional accuracy is 1.0% or less, the dimensional accuracy is sufficiently excellent. Therefore, the carbon content rate of the carbon-containing material is preferably 90% or more. On the other hand, as shown in (b) in FIG. 4, in a case where the carbon content rate of the carbon-containing material is excessively increased, the strength of the molded product is decreased. Therefore, in order to maintain the strength sufficiently, the carbon content rate of the carbon-containing material is preferably set to, for example, 95% or less.

As shown in FIG. 1, the sensor 40 is connected to the vent passage 10 and detects a physical quantity in the vent passage 10 and a system to be diagnosed. The system to be diagnosed communicates with the vent passage 10. The physical quantity may be a pressure, a temperature, a gas density, and/or the like. In the present embodiment, the pressure is detected as the physical quantity.

As shown in FIG. 1, the leakage diagnosis unit 50 performs the leakage diagnosis based on the detection result of the sensor 40. In the present embodiment, the leakage diagnosis unit 50 is embodied with a specific program that is executed by an ECU 9. The ECU 9 is provided to the internal combustion engine 2.

The component formed of the above-described carbon-containing material may be formed by powder molding that is performed by injecting powder directly into a molding die. This molding process enables to eliminate a runner that is for carrying the material to flow into the mold, thereby enhancing the manufacturing yield. In addition, this molding process enables not to form a gate, which is a connection portion between the runner and the molding die, thereby to enable to omit a manufacturing process to remove the gate from the molded product and to enable to simplify the manufacturing process.

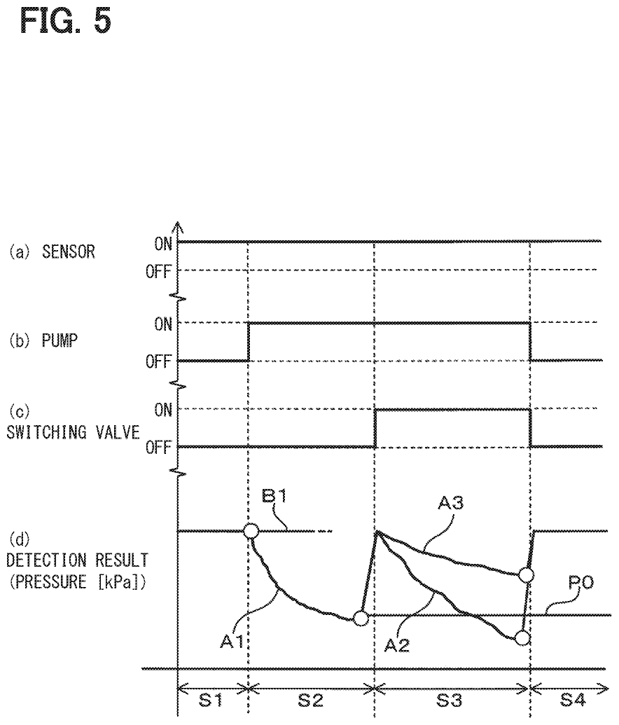

Subsequently, the leakage diagnosis of the leakage diagnosis device 1 according to the present embodiment will be described with reference to a time chart shown in FIG. 5.

In the leakage diagnosis, the leakage diagnosis device 1 first checks the operation of the pump 20. As shown in FIG. 5, in a first period 51 as an initial state, the sensor 40 is turned on as shown in (a), the pump 20 is turned off as shown in (b), and the switching valve 30 is closed as shown in (c). Although not shown, the purge valve 31 is kept closed in the leakage diagnosis.

Thereafter, in a second period S2, the pump 20 is turned on as shown in (b). In this way, the pump 20 discharges vapor in the vent passage 10 to the atmosphere side. As shown in (d), when the pump 20 is normal, a pressure drop indicated by a line denoted by a reference symbol A1 is detected as a detection result of the sensor 40. On the other hand, when an abnormality occurs in the pump 20, the pressure is not reduced by the pump 20, and pressure drop is not detected as indicated by a line denoted by a reference symbol B1.

When it is confirmed that the operation of the pump 20 is normal, the switching valve 30 is opened in a subsequent third period S3 as shown in (c). As a result, the vent passage 10 in the reduced pressure state communicates with the system to be diagnosed, which is in the normal pressure state. Therefore, as shown in (d), the pressure increase is temporarily detected as a detection result of the sensor 40. Thereafter, the operation of the pump 20 is continued, and consequently, pressure drop is observed as a detection result of the sensor 40.

In a case where the pressure detected by using the sensor 40 decreases below a predetermined specified value, as indicated by the line denoted by a reference symbol A2 in (d), it is determined that leakage exceeding a regulation value has not occurred in the system to be diagnosed. To the contrary, as indicated by the line denoted by a reference symbol A3 in (d), when the sensor 40 does not detect a pressure drop exceeding the predetermined specified value, it is determined that a leakage exceeding the regulated value has occurred in the system to be diagnosed. Subsequently, after the determination is completed, in a fourth period S4, the pump 20 is turned off as shown in (b), thereby to return the system to be diagnosed and the inside of the vent passage 10 to the atmospheric pressure. In addition, the switching valve 30 is closed as shown in (c), thereby to block the system to be diagnosed from the atmosphere side. Thus, the leakage diagnosis is terminated. The specified value of the pressure drop may be set as appropriate.

Subsequently, the operational effect of the leakage diagnosis device 1 of the present embodiment will be described in detail.

In the leakage diagnosis device 1 according to the present embodiment, the rotor 21 is the rotational portion of the pump 20, and the vanes 22, the casing 23, the plate 24, and the vent passage 10 are the contact portion that make contact with the rotating portion. The rotor 21 decreases and/or increases the pressure in the system to be diagnosed in the evaporative fuel treatment device 5. At least a portion of the rotor 21, at least a portion of the vanes 22, at least a portion of the casing 23, at least a portion of the plate 24, and at least a portion of the vent passage 10 is formed of the carbon-containing material containing carbon as a main component. These components are formed of the carbon-containing material that is high in molding dimensional accuracy, and thus exhibit sufficiently high molding accuracy after being molded in a molding die. As a result, these components do not require a polishing process after being molded in the molding die, and therefore enable to omit a step of the polishing process and thereby to enable to enhance the manufacturing yield.

In the present embodiment, the rat e of carbon content (carbon content rate) of the carbon-containing material is 90% or more. Therefore, the molding accuracy of the component formed of the carbon-containing material may be sufficiently increased, and the manufacturing yield thereof may be further enhanced.

In the present embodiment, the carbon content rate of the carbon-containing material is 95% or less. Therefore, the strength of the component formed of the carbon-containing material may be sufficiently secured, thereby to enable to further enhance reliability of the molded component.

Further, in the present embodiment, both the rotor 21, which is the rotational portion, the vanes 22, the casing 23, and the plate 24, which are the contact portion, are formed of the carbon-containing material. That is, the components of the pump 20, which come into sliding contact with each other, are formed of the same kind of material. Therefore, the materials are easily compatible with each other, thereby to enhance slidability of those components.

In the present embodiment, the pump 20 is a vane pump including the vanes 22. The vanes 22 are formed of the carbon-containing material. The pump 20 that is the vane pump enables to exhibit a stable pump performance. In addition, the configuration enables to suppress wear of the vanes 22, thereby to further stabilize the pump performance.

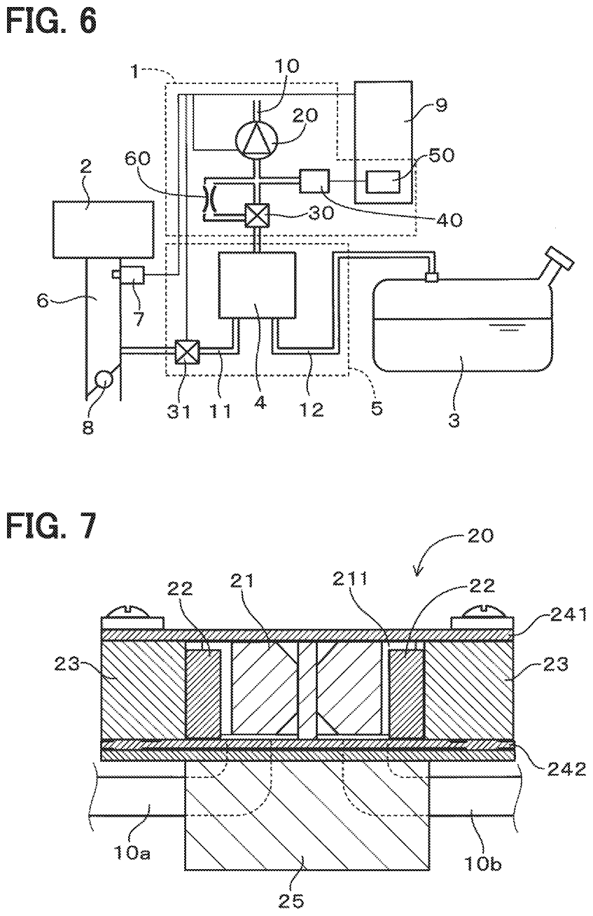

As in a modification 1 shown in FIG. 6, the configuration of the present embodiment may be modified as follows. Specifically, in this modification, the switching valve 30 may have a three-way valve structure, and a throttle 60 may be connected in parallel to the vent passage 10 via the switching valve 30. In this first modification, in the leakage diagnosis, in the second period S2 shown in FIG. 5, the sensor 40 detects a reference pressure for detecting the differential pressure in the throttle 60. In the subsequent third period S3, the leakage diagnosis of fuel vapor may be performed based on the differential pressure between the pressure detected by using the sensor 40 and the reference pressure.

Further, in the present embodiment, as shown in FIG. 2, the pump 20 has the configuration in which the rotor 21 is placed between the casing 23, which forms the cam ring, and the plate 24. It is noted that, the configuration is not limited to this configuration. As shown in FIG. 7, a configuration may be employable, in which the casing 23 forming the cam ring is provided between a pair of plates 241 and 242, and in which the rotor 21 is placed inside the casing 23. The pair of plates 241 and 242 may be formed of the carbon-containing material. In this configuration, although the number of components is increased, the casing 23 has a simple shape, thereby to enable to facilitate its manufacturing process.

As described above, the present embodiment enables to provide the leakage diagnosis device 1 that enables to enhance its manufacturing yield.

One or more, or all of the rotational portion 21, the contact portions 22, 23, 24, 241, 242 and the vent passage 10 may be formed of the carbon-containing material. The rotational portion 21, the contact portions 22, 23, 24, 241, 242 and/or the vent passage 10, which is formed of the carbon-containing material, may be entirely formed of the carbon-containing material or may be partially formed of the carbon-containing material.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A leakage diagnosis device configured to diagnose leakage of vapor in an evaporative fuel treatment device, the evaporative fuel treatment device including a canister that is configured to adsorb fuel vapor arising in a fuel tank of an internal combustion engine, the leakage diagnosis device comprising:
a vent passage that is connected to a system to be diagnosed and that opens to atmosphere, the system to be diagnosed including the canister;
a pump that is connected to the vent passage and is configured to decrease and increase pressure in the system to be diagnosed in the evaporative fuel treatment device;
a switching valve that is provided to the vent passage and is configured to switch a communication state between the vent passage and the system to be diagnosed;
a sensor configured to detect a physical quantity in the system to be diagnosed; and
a leakage diagnosis unit that is configured to perform leakage diagnosis based on a detection result of the sensor, wherein
at least a part of a rotational portion of the pump, a contact portion of the pump, and the vent passage is formed of a carbon-containing material,
the contact portion is in contact with the rotational portion, and
the carbon-containing material is mainly composed of carbon.

2. The leakage diagnosis device according to claim 1, wherein
a carbon content rate of the carbon-containing material is 90% or more.

3. The leakage diagnosis device according to claim 2, wherein
the carbon content rate of the carbon-containing material is 95% or less.

4. The leakage diagnosis device according to claim 1, wherein
both the rotational portion and the contact portion are formed of the carbon-containing material.

5. The device according to claim 1, wherein
the pump is a vane pump including a vane, and
the vane is formed of the carbon-containing material.

6. The device according to claim 1, wherein
at least one of the rotational portion, the contact portion, and the vent passage is formed of the carbon-containing material.
